(19) United States
(12) Patent Application Publication
(10) Pub. No.: US 2021/0149404 A1
(43) Pub. Date: May 20, 2021

(54) Systems and Methods for Jointly Performing Perception, Perception, and Motion Planning for an Autonomous System

(71) Applicant: UATC, LLC, San Francisco, CA (US)

(72) Inventors: Wenyuan Zeng, Toronto (CA); Shenlong Wang, Toronto (CA); Renjie Liao, Toronto (CA); Yun Chen, Toronto (CA); Bin Yang, Toronto (CA); Raquel Urtasun, Toronto (CA)

(21) Appl. No.: 17/022,923

(22) Filed: Sep. 16, 2020

Related U.S. Application Data
(60) Provisional application No. 63/033,361, filed on Jun. 2, 2020.
(60) Provisional application No. 62/936,415, filed on Nov. 16, 2019.

(51) Int. Cl. G05D 1/02; G05D 1/00; G01S 17/89; G06T 7/20; G06K 9/32

(52) U.S. Cl. CPC G05D 1/0212; G05D 1/0088; G01S 17/89; G06T 2207/30252; G06K 9/3241; G06T 2207/10028; G06T 7/20

(57) ABSTRACT

The present disclosure is directed to generating trajectories using a structured machine-learned model. In particular, a computing system can obtain sensor data for an area around an autonomous vehicle. The computing system can detect one or more objects based on the sensor data. The computing system can determine a plurality of candidate object trajectories for each object in the one or more objects. The computing system can generate, using the plurality of candidate object trajectories as input to one or more machine-learned models, likelihood data for the plurality of candidate object trajectories. The computing system can update the likelihood values for each of the plurality of candidate object trajectories for each respective object in the one or more objects based on the likelihood values associated with candidate object trajectories for other objects in the one or more objects. The computing system can determine a motion plan for the autonomous vehicle.

### RELATED APPLICATION

This application claims priority to and the benefit of U.S. Provisional Patent Application No. 62/936,415, filed Nov. 16, 2019 and U.S. Provisional Patent Application No. 63/033,361, filed Jun. 2, 2020 which are hereby incorporated by reference in its entirety.

### FIELD

The present disclosure relates generally to autonomous vehicles. More particularly, the present disclosure relates to generating motion plans for an autonomous vehicle.

### BACKGROUND

An autonomous vehicle is a vehicle that is capable of sensing its environment and navigating without human input. In particular, an autonomous vehicle can observe its surrounding environment using a variety of sensors and can attempt to comprehend the environment by performing various processing techniques on data collected by the sensors. Using this data the autonomous vehicle can generate a motion plan to navigate to a target destination.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include obtaining, by a computing system with one or more processors, sensor data for an area around an autonomous vehicle. The method can include detecting, by the computing system, one or more objects in the area around the autonomous vehicle based at least in part on the sensor data. The method can include determining, by the computing system using one or more machine-learned models, a plurality of candidate object trajectories for each object in the one or more objects. The method can include, for each respective object in the one or more objects, generating, by the computing system using one or more machine-learned models, a likelihood value for each candidate object trajectory in the plurality of candidate object trajectories. The method can include updating, by the computing system using the one or more machine learned models, the likelihood values for each of the plurality of candidate object trajectories for each respective object in the one or more objects based on the likelihood values associated with candidate object trajectories for other objects in the one or more objects. The method can include determining, by the computing system, a motion plan for the autonomous vehicle. Determining the motion plan can comprise generating, by the computing system, a plurality of candidate vehicle trajectories for the autonomous vehicle, generating, by the computing system using the one or more machine-learned models, a cost value for each candidate vehicle trajectory in the plurality of candidate vehicle trajectories for the autonomous vehicle, determining, by the computing system, a pairwise cost for each respective candidate vehicle trajectory for the autonomous vehicle based, at least in part, on the cost value for the respective candidate trajectory for the autonomous vehicle and the updated likelihood values for the candidate object trajectories for the one or more objects, and selecting, by the computing system, a candidate vehicle trajectory from the plurality of candidate vehicle trajectories.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts a block diagram of an example autonomous vehicle according to example embodiments of the present disclosure.

FIG. 2 depicts a block diagram of a method for generating routes using a machine learned model according to example embodiments of the present disclosure.

FIG. 3A depicts a diagram of a structured machine-learned model according to example embodiments of the present disclosure.

FIG. 3B depicts a diagram of a backbone feature map according to example embodiments of the present disclosure.

FIG. 4A depicts an example detection map according to example embodiments of the present disclosure.

FIG. 4B depicts example prediction and planning data according to example embodiments of the present disclosure.

FIG. 4C depicts example prediction uncertainty data according to example embodiments of the present disclosure.

FIG. 5 depicts a flow chart diagram of an example method according to example embodiments of the present disclosure.

FIG. 6 depicts an example system with units for performing operations and functions according to example aspects of the present disclosure.

FIG. 7 depicts example system components according to example aspects of the present disclosure.

### DETAILED DESCRIPTION

Generally, the present disclosure is directed to a machine-learned model for performing perception, prediction, and motion planning for an autonomous vehicle and/or another robotic system. To achieve this goal, a system can utilize a single, deep structured machine-learned model (e.g., convolutional neural network) trained to perform these functions. By way of example, the system can receive sensor data from a LIDAR system in an autonomous vehicle. The sensor data and map data for the area around the autonomous vehicle can be submitted as input to a machine-learned model (e.g., convolutional neural network). The machine-learned model can be a deep structured self-driving network. As such, the model can be configured into a plurality of modules, each module producing an intermediate representation that is used as input to the next module, until the final module outputs a selected route. To do so, the model can, for example, convert the sensor data into a three-dimensional tensor representation. Using this intermediate representation of the sensor data as input to an object detection module, the model can detect one or more objects (e.g., other vehicles, pedestrians, bicyclists, and so on) in the area around the autonomous vehicle and output an intermediate representation of the one or more detected objects.

The intermediate representation (e.g., a detection header) of the one or more detected objects can be used as input to the motion forecasting module of the machine-learned model. This intermediate representation can include data describing the location of one or more objects (e.g., actors) and their initial velocities. The motion forecasting module can use the detection header to predict how the one or more objects could potentially behave in the next few seconds. More specifically, the motion forecasting module can model the joint distribution of this representation (the position and velocity of objects) to capture the dependencies between all the objects and produce a probabilistic multimodal output.

This probabilistic multimodal output is an intermediate representation of the likely movement of one or more objects (or actors) in the area around the autonomous vehicle. Once data describing the probabilities associated with different trajectories of the other objects is generated, the motion planning module can accept, as input, the current position, direction, and destination of the autonomous vehicle. Based on this information, the motion planning module of the machine-learned model can generate one or more candidate trajectories for the autonomous vehicle. Each candidate trajectory can be evaluated to generate a unary cost for the trajectory. The unary cost can reflect the estimated cost (where a lower cost is better) associated with each candidate vehicle trajectory. Once the unary cost has been generated, it can be combined with the probabilistic representations of the other objects to generate a pairwise cost (e.g., considering the likely positions and trajectories of the other actors in the area) for each candidate trajectory for the autonomous vehicle.

The machine-learned model can produce a pairwise cost for each candidate vehicle trajectory. The candidate vehicle trajectory with the lowest pair-wise cost can be selected and transmitted for controlling the motion of the autonomous vehicle (e.g., to the vehicle controller). Using multiple measures of cost, the structured machine-learned model can ensure that selected trajectories can both ensure particular safety measures are followed (e.g., ensuring that the autonomous vehicle stops as stop signs) using formal costing rules and the machine-learned models can select safe routes. Thus, autonomous vehicles can include this machine-learned model to provide safe, reliable trajectory selection from a single machine-learned model. The model can be included as one aspect of a larger autonomous driving system.

More specifically, an autonomous vehicle can include a vehicle computing system. The vehicle computing system can be responsible for, among other functions, creating the control signals needed to effectively control an autonomous vehicle. The vehicle computing system can include an autonomy computing system. The autonomy computing system can include one or more systems that enable the autonomous vehicle to obtain a route, receive sensor data about the environment, perceive objects within the vehicle's surrounding environment (e.g., other vehicles), predict the motion of the objects within the surrounding environment, generate trajectories based on the sensor data, and perception/predicted motion of the objects, and, based on the trajectory, transmit control signals to a vehicle control system and thereby enable the autonomous vehicle to move to its target destination (e.g., while generally following the route).

To accomplish these operations, the autonomy computing system can include, for example, a perception system, a prediction system, and a motion planning system. As noted above, many of the functions performed by the perception system, prediction system, and motion planning system can be performed, in whole or in part, by a single structured machine-learning model.

To help maintain awareness of the vehicle's surrounding environment, the vehicle computing system (e.g., the perception system) can access sensor data from one or more sensors to identify static objects and/or dynamic objects (actors) in the autonomous vehicle's environment. To help determine its position within the environment (and relative to these objects), the vehicle computing system can provide sensor data to the structured machine-learned model. In addition, the autonomous vehicle can determine its current location and access high-definition maps for that location.

The structure machine-learned model can include a backbone network. The backbone network can take raw sensor data as input in the form of LiDAR point clouds and a high-definition map for the area near the autonomous vehicle. In some examples, the backbone network can receive LiDAR data from a plurality of subsequent time steps. For example, the backbone network can receive LiDAR data during ten consecutive LiDAR sweeps (instances in which LiDAR gathers data). The LiDAR data from each sweep can be transformed into a form such that the data included therein follows a coordinate system that represents the location of the data relative to the autonomous vehicle (e.g., an ego-coordinate system).

In some examples, the LiDAR point cloud data can be processed to generate a voxelized representation of the point cloud data. A voxelized representation of an area can be a representation in which the three-dimensional space is divided up into a plurality of equally sized sub-spaces, wherein each sub-space is represented by a data value.

The backbone network can create the voxelized representation with a three-dimensional occupancy tensor for the plurality of LiDAR sweeps. For each sweep, the backbone network can generate a three-dimensional occupancy tensor for each location in the area represented. Thus, each sub-space (represented by a particular voxel) in the three-dimensional space can have an associated binary value for each time period representing whether the three-dimensional space includes a point in the point cloud during that time period. As an object moves through the three-dimensional space, the occupancy values associated with a particular sub-space can vary.

The tensors for each of the plurality of sweeps can be concatenated along the height dimension. Doing so can result in a three-dimensional tensor (e.g., a time dimension added to the existing tensor data).

The high definition maps can also be used as strong signals for detection, prediction, and planning as autonomous vehicles typically follow the rules of traffic (e.g., they are typically on the road). The backbone network portion of the structured machine-learned model can rasterize one or more lanes within the high definition maps with different semantics (e.g., straight, turning, blocked by a traffic light) into different channels and concatenate them with the three dimensional tensor to form a representation of the sensor input.

As such, the representation produced as a result of the above transformation of the LiDAR data and high definition map data can be formatted as a three-dimensional tensor X∈ [symbol] ^{C×Q×H}, where W and H are the width and height, and C is the total number of channels for both the LiDAR data and map.

This representation can be used as input to the next portion of the machine-learned model to detect one or more objects (e.g., actors) in the area. An object may be another vehicle, pedestrian, bike, or another object capable of movement. In addition, the machine-learned model can predict the location and velocity of each detected object. This information can be integrated into a representation of the area and stored in a detection header. The detection header can include two layers, one for classification and one for regression.

The classification layer can include a plurality of classification scores, one for each location within the space by the machine-learned model. The classification score can represent the likelihood that an object is present at the location. The regression layer can include the offset values at each location. These offset values include position offset, size, heading angle, and velocity. The two layers can be used in concert to determine the bounding boxes for all objects and their initial speeds.

Using the location and initial speeds for each object, the prediction portion of the machine-learned model can predict how each object could potentially behave in the near future (e.g., a few seconds into the future). The deep structured machine-learned model can generate a joint distribution of all objects' future behavior to capture the dependencies among all objects and produces probabilistic multi-modal outputs. More specifically, the machine-learned model can initially generate a plurality of candidate future trajectories.

Formally, let sᵢ be the candidate future trajectory of the i-th object, and let S={sᵢ}_{i=i, . . . , N} be the set of candidate trajectories for all objects in the scene. The candidate trajectory can be represented as a set of 2D coordinates at fixed discrete future timestamps, e.g., 1 s, 2 s, 3 s. The motion forecasting module can generate, for each candidate trajectory, a likelihood value of that object following the trajectory. In some examples, the likelihood value can include the “goodness” of a given trajectory for that object, wherein goodness represents the degree to which the trajectory could feasibly be accomplished in the real world or the unary potential of a given path. For example, the likelihood value can be generated based, at least in part, on modeling the physical dynamics and traffic-rules of the area and the object. For example, turning sharply with high speed in front of a red light is not very likely to happen in the real world.

To ensure that the model can efficiently and quickly analyze a large number of candidate trajectories (e.g., have a high model capacity), the motion forecasting module can include a deep neural network to construct the likelihood values for each candidate trajectory. Given a candidate future trajectory sᵢ for the i-th object, the motion forecasting module can extract its feature representation by indexing the corresponding locations from the backbone feature map. Specifically, based on the detected bounding box of the i-th object, the motion forecasting module can apply region of interest (ROI) pooling to the backbone feature map followed by several convolution layers to compute the object's feature data. Note that the backbone feature data used to compute the object's feature data can be generated by the backbone network during the detection step. The feature data can encode rich information about the environment.

The motion forecasting module can use the same procedure to get the feature representation for every candidate trajectory and concatenate them together with (xₜ; yₜ; cos(θₜ), sin(θₜ), distanceₜ) to form the trajectory feature. Using the object feature data (e.g., based on data about the object) and the trajectory feature data (e.g., based on information about the trajectory) and use both features as input to the multilayer perceptron. The output of the MLP can be a likelihood score for each of the plurality of trajectories. Finally, we feed both object and trajectory features into an MLP, to construct the likelihood value (or unary score) for the trajectory.

Once a unary score is determined for the plurality of trajectories, the motion prediction module can, through a message-passing step, generate an updated likelihood value (or pairwise score) that measures the consistency between two different objects' behaviors given the scene, (e.g., whether trajectory sᵢ collides with sⱼ). In some examples, likelihood scores can be updated by detecting collisions between two actors or objects when they execute their trajectories. In other examples, this adjustment can be determined using a learnable deep neural network.

The vehicle computing system (e.g., motion planning system) can use the output(s) from the perception and prediction stages of the machine-learned model to generate a motion plan for the vehicle. For example, a route can describe a specific path for the autonomous vehicle to travel from a current location to a destination location. A motion planning module in the structured machine-learned model can generate candidate trajectories for the autonomous vehicle to follow as it traverses the route. Each candidate trajectory can be executable by the autonomous vehicle (e.g., feasible for the vehicle control systems to implement). Each trajectory can be generated to comprise a specific amount of travel time (e.g., eight seconds or another amount of time).

The motion planning module can be used to generate a trajectory going forward towards a goal while avoiding collision with other objects. A plurality of candidate trajectories can be generated and evaluated to determine which candidate trajectory will be the most advantageous for the autonomous vehicle. For example, the following formula can be used to determine the cost for a given trajectory.

$$C ( τ , X ) = {C}_{u} ( τ , X ) + {𝔼}_{Pw ( s \vert x )} [ {\sum }_{i = 1}^{N} {C}_{pa} ( τ , {s}_{i} , X ) ]$$

where Cᵤ and Cₚₐ are the unary and pairwise cost functions respectively. The unary cost can evaluate how well a trajectory follows the autonomous vehicle's dynamic behavior, goal-oriented progress, and traffic rules. The vehicle features and trajectory features can be extracted from the backbone network. The motion planning module can use a separate MLP to compute a scalar value for the unary cost. Once the unary cost is calculated, the motion planning module can calculate the pairwise cost that explicitly models the interaction (e.g., social interactions or vehicular interactions) between the autonomous vehicle and other objects' motion, e.g., how likely two cars are to collide, one should yield to others, etc. Thus, the final cost can include a representation of factors associated with the autonomous vehicle and its environment and the uncertainty in predicting the motion of other objects in the area. The model can then select a particular trajectory based on the calculated pairwise cost.

The autonomous vehicle can select and implement a trajectory for the autonomous vehicle to navigate a specific segment of the route. For instance, the selected trajectory can be translated and provided to the vehicle control system(s) that can generate specific control signals for the autonomous vehicle (e.g., adjust steering, braking, velocity, and so on). The specific control signals can cause the autonomous vehicle to move in accordance with the selected trajectory.

This method involves a great deal of computation to provide end-to-end motion planning in real-time. For any given scenario (X), the goal is to determine a trajectory with a minimum cost. To determine the cost of each trajectory, the system can compute the costs of the trajectory without respect to any other actors or objects (unary cost) and the expected costs with respect to the joint distribution of objects' function behavior. Although the individual costs can be efficiently evaluated with a single forward pass, the continuously changing nature of calculating the autonomous vehicle's (ego car's) trajectory and potential trajectories of the other objects in the area, makes it difficult to estimate the expectation and minimization efficiently.

To overcome these issues, the current implementation can approximate the original continuous decision space S using discretization, with the hope that the model can perform tractable inference without sacrificing much expressiveness. More specifically, after the objects are detected, the system can sample a finite number of future trajectories based on the initial locations and speed of the objects. The system can then constrain the future decision space of each object to be the trajectory samples. This can discretize the original continuous space. A similar process can be used to constrain the number of candidate vehicle trajectories considered.

Through the above discretization process, the structured model can provide realistic yet diverse trajectories. This ensures the discretized decision space covers the most probable solutions in the original space and gives a good approximation. Using this approximation, the system can solve the problem of selecting the best trajectory by enumerating over the selected plurality of candidate vehicle trajectories and selecting the one with the minimal cost value

The cost for a particular trajectory τ can be determined by the following formula:

$$C ( τ , X ) \approx {C}_{u} ( τ , X ) + {\sum }_{i = 1}^{N} {\sum }_{k = 1}^{K} {p}_{w} ( {s}_{i} = {s}_{i}^{k} \vert X ) {C}_{pa} ( τ , {s}_{i} , X ) ,$$

where the system approximates sᵢ using samples {sᵢ^{k}}. Using this formula, allows the system to use a marginal distribution instead of the computationally expensive join variable distribution. Furthermore, since our sᵢ is a discrete random variable, the system can leverage the efficient belief propagation algorithm, a.k.a., sum-product message passing, to estimate the marginals per object. Specifically, the system can conduct the following update rule in an iterative manner,

$${m}_{ij} ( {s}_{j} ) ∝ {\sum }_{{s}_{i} ∈ \{ {s}_{i}^{k} \}} {e}^{- φ ( {s}_{i} ) - ψ ( {s}_{i} , {s}_{j} )} {\prod }_{n \neq i , j} {m}_{ni} ( {s}_{i} )$$

wherein mᵢⱼ is the message sent from node i to j (a first and second object). After message passing has been conducted for a fixed number of steps, the system can compute the approximated marginal as follows,

$${p}_{w} ( {s}_{i} = {s}_{i}^{k} \vert X ) = {e}^{- φ ( {s}_{i}^{k} )} {\prod }_{j \neq i} {m}_{ji} ( {s}_{i}^{k} )$$

Thus, in summary, given the input X, the system first applies the backbone network to compute the intermediate feature map. The perception module is then used to detect N objects with its initial state at t=0. Trajectory sampling is applied to get K feasible trajectories for each detected object (or actor) and the autonomous vehicle. The unary costs for the objects and the autonomous vehicle can then be computed in an end-to-end manner for each state of an object. Afterwards, the pairwise costs are evaluated efficiently through a GPU-based IoU computation for checking if two objects collide. Belief propagation is then conducted over the densely connected object graph to estimate each object's marginal. Finally, the best motion planning trajectory is chosen by searching for the one with minimal cost.

The following provides an end-to-end example of the technology described herein. An autonomous vehicle can travel through a particular three-dimensional space. The autonomous vehicle can include one or more sensors. A structured machine-learned model can obtain sensor data for an area around an autonomous vehicle. In some examples, the machine-learned model can be a structured network that includes a plurality of subsections with each subsection producing an interpretable intermediate representation.

In some examples, the structured machine-learned model can process the sensor data to produce an intermediate representation of the area around the autonomous vehicle. Producing the interpretable intermediate representation of the area around the autonomous vehicle can include, for example, generating, using the machine-learned model, a plurality of voxelized representations of the sensor data at a plurality of time steps.

Each voxel can include a binary value indicating whether the voxel includes a LIDAR point. The structured machine-learned model can concatenate the voxelized representation of the sensor data at a plurality of time steps to generate a three-dimensional tensor representation of the sensor data.

The structured machine-learned model can detect one or more objects in the area around the autonomous vehicle based at least in part on the sensor data. The objects can include actors such as vehicles, pedestrians, bicyclists, and any other moving objects. The detected objects can be included in an intermediate representation that includes data describing one or more features of the object including the location of the object, the size of the object, the current velocity, etc.

The structured machine-learned model determines a plurality of candidate object trajectories for each object in the one or more objects. Each trajectory can be represented as a series of coordinates for a series of time steps (e.g., 1 second, 2 seconds, 3 seconds, and so on). For each respective object in the one or more objects, the structured machine-learned model generates a likelihood value for each candidate object trajectory in the plurality of candidate object trajectories.

The structured machine-learned model can, for each object in the one or more objects, determine feature data for the object. The structured machine-learned model can determine trajectory feature data for each candidate trajectory. The structured machine-learned model can, using the object feature data and the trajectory feature data as input to a motion forecasting module of the machine-learned model, generate likelihood values for each candidate trajectory for the object. The object feature data can represent data determined based on region of interest pooling. Trajectory feature data associated with an object or actor can include the coordinates of the object at a sequence of timestamps. This information can represent the path of the trajectory overtime.

In some examples, the likelihood values represent the goodness of the trajectory or the likelihood that the object will move along that trajectory. In some examples, the structured machine-learned model can provide environmental feature data as input to a motion forecasting module.

The structured machine-learned model can update the likelihood values for the plurality of candidate object trajectories for each respective object in the one or more objects based on the likelihood values associated with candidate object trajectories for other objects in the one or more objects. The structured machine-learned model can generate updated likelihood values at least in part based on a message-passing stage in which the likelihood values for a respective plurality of candidate object trajectories associated with the respective object are compared to likely trajectories of one or more other candidates.

The structured machine-learned model can generate a plurality of candidate vehicle trajectories for the autonomous vehicle. The trajectories can be determined based on the original position of the object, the original velocity of the object, high definition map data, legal considerations, pass trajectory information, and so on. The structured machine-learned model can generate a cost value for each candidate trajectory in the plurality of candidate vehicle trajectories for the autonomous vehicle. The cost value for each candidate trajectory for the autonomous vehicle can be a unary cost value.

The unary cost value can be generated by using feature data associated with the autonomous vehicle and feature data associated with one or more candidate vehicle trajectories as input to a motion planning module of the machine-learned model. In some examples, the structured machine-learned model can provide environmental feature data as input to the motion forecasting module. The environmental feature data can indicate, for example, the position of unmoving obstacles (e.g., trees or road barriers), data describing current environmental conditions (e.g., road surface conditions), data describing the geographic features of the area (e.g., the slope of the current road), etc.

The structured machine-learned model can determine a pairwise cost for each respective candidate vehicle trajectory for the autonomous vehicle based, at least in part, on the cost value for the respective candidate trajectory for the autonomous vehicle and the updated likelihood values for the candidate object trajectories for the one or more objects. The structured machine-learned model can select a trajectory with the lowest calculated cost. The trajectory can be transmitted to the vehicle controller for use in controlling the autonomous vehicle.

The systems and methods described herein provide a number of technical effects and benefits. More particularly, the systems and methods of the present disclosure provide improved techniques using a machine-learned model to perform the detection, prediction, and motion planning functions of an autonomous vehicle. Previous versions of the motion planners either utilized an end-to-end model or a designed engineering stack. An end-to-end model takes sensor data as input and outputs vehicle controls without intermediate representations during the process. This can be easy to build but requires large amounts of training data and does not guarantee safety. Alternatively, a designed engineering stack can break the problem into sections, each section producing an interpretable representation. This method is very inflexible and cannot recover from mistakes in upstream tasks. The present method combines the two approaches, implementing an end-to-end model that explicitly creates an interpretable intermediate representation as part of the process. This process is designed to explicitly capture interaction between objects and provides multimodal uncertainty estimates over their future trajectories. As a result, the current process can perform the detection, prediction, and motion planning steps more efficiently and safely. This results in a reduction in the amount of processing cycles necessary, reducing the amount of data storage needed, and reducing the amount of energy used by the system, all other things being equal. Reducing energy consumption increases the useful battery life of any battery systems included in the autonomous vehicle.

Faster and more efficient analysis can ensure that an autonomous vehicle correctly identifies any objects in its vicinity and plans a correct route. Doing so allows autonomous vehicles to be controlled in a manner that is both safer and more efficient.

Various means can be configured to perform the methods and processes described herein. For example, a computing system can include data obtaining unit(s), object detection unit(s), trajectory generation unit(s), motion forecasting unit(s), motion planning unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain sensor data for an area around an autonomous vehicle. For example, a LIDAR sensor associated with an autonomous vehicle can capture point cloud data for a space around the autonomous vehicle and provide that data to a machine-learned model. A data obtaining unit is one example of a means for obtaining sensor data for an area around an autonomous vehicle.

The means can be configured to detect one or more objects in the area around the autonomous vehicle based at least in part on the sensor data. A detection module can analyze the sensor data to identify the position and velocity of one or more objects in the area. This information can be stored as a detection header and provided to the model as input. An object detection unit is one example of a means for detecting one or more objects in the area around the autonomous vehicle based at least in part on the sensor data.

The means can be configured to determine, using one or more machine-learned models, a plurality of candidate object trajectories for each object in the one or more objects. For example, the candidate object trajectory can be determined based on the current position and velocity of the object, high definition map data, and data describing legal considerations at the area of the object. A trajectory generation unit is one example of a means for determining, using one or more machine-learned models, a plurality of candidate object trajectories for each object in the one or more objects.

The means can be configured to generate, using one or more machine-learned models, a likelihood value for each candidate object trajectory in the plurality of candidate object trajectories and update, using the one or more machine learned models, the likelihood values for the plurality of candidate object trajectories for each respective object in the one or more objects based on the likelihood values associated with candidate object trajectories for other objects in the one or more objects. For example, the motion forecasting unit can determine the likelihood that each candidate object trajectory will occur and then adjust those likelihood values based on the likely movement of the other objects. An encoder unit is one example of a means for generating, using one or more machine-learned models, a likelihood value for each candidate object trajectory in the plurality of candidate object trajectories and updating, using the one or more machine learned models, the likelihood values for the plurality of candidate object trajectories for each respective object in the one or more objects based on the likelihood values associated with candidate object trajectories for other objects in the one or more objects.

The means can be configured to determine a motion plan for the autonomous vehicle. For example, the motion planning module can generate a plurality of candidate vehicle trajectories for the autonomous vehicle, generate, using the one or more machine-learned models, a cost value for each candidate trajectory in the plurality of candidate vehicle trajectories for the autonomous vehicle, and determine a motion plan for the autonomous vehicle, based at least in part, on the updated likelihood values for the plurality of candidate object trajectories for each respective object. A motion planning unit is one example of a means for determining a motion plan for the autonomous vehicle.

With reference to the figures, example embodiments of the present disclosure will be discussed in further detail.

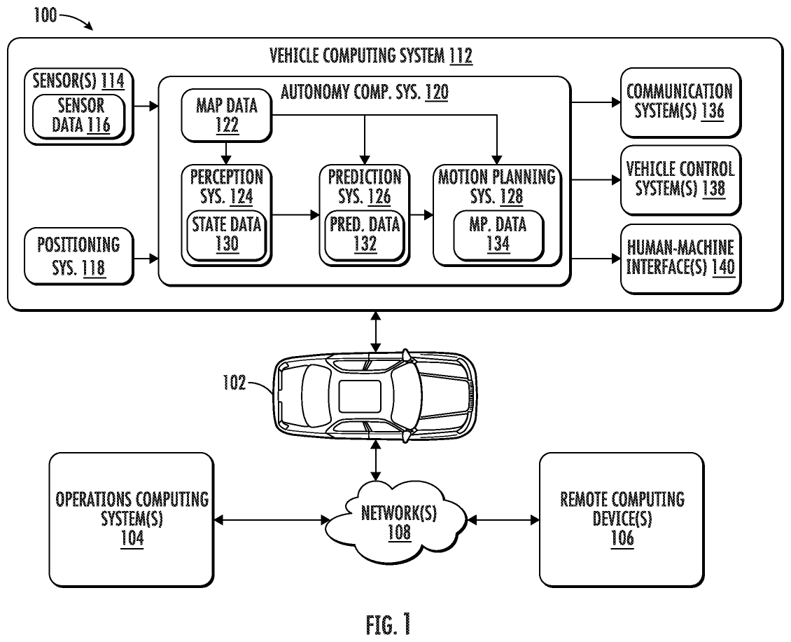

FIG. 1 depicts a block diagram of an example system 100 for controlling the navigation of a vehicle according to example embodiments of the present disclosure. As illustrated, FIG. 1 shows an example system 100 that can include an autonomous vehicle 102, an operations computing system 104, one or more remote computing devices 106, a communication network 108, a vehicle computing system 112, one or more autonomy system sensors 114, autonomy system sensor data 116, a positioning system 118, an autonomy computing system 120, map data 122, a perception system 124, a prediction system 126, a motion planning system 128, state data 130; prediction data 132, motion plan data 134, a communication system 136, a vehicle control system(s) 138, and a human-machine interface 140.

The operations computing system 104 can be associated with a service provider (e.g., service entity) that can provide one or more vehicle services to a plurality of users via a fleet of vehicles (e.g., service entity vehicles, third-party vehicles, etc.) that includes, for example, the autonomous vehicle 102. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the autonomous vehicle 102. The one or more computing devices of the operations computing system 104 can include one or more processors and one or more memory devices. The one or more memory devices of the operations computing system 104 can store instructions that when executed by the one or more processors cause the one or more processors to perform operations and functions associated with the operation of one or more vehicles (e.g., a fleet of vehicles), with the provision of vehicle services, and/or other operations as discussed herein.

For example, the operations computing system 104 can be configured to monitor and communicate with the autonomous vehicle 102 and/or its users to coordinate a vehicle service provided by the autonomous vehicle 102. To do so, the operations computing system 104 can manage a database that stores data including vehicle status data associated with the status of vehicles including autonomous vehicle 102. The vehicle status data can include a state of a vehicle, a location of a vehicle (e.g., a latitude and longitude of a vehicle), the availability of a vehicle (e.g., whether a vehicle is available to pick-up or drop-off passengers and/or cargo, etc.), and/or the state of objects internal and/or external to a vehicle (e.g., the physical dimensions and/or appearance of objects internal/external to the vehicle).

The operations computing system 104 can communicate with the one or more remote computing devices 106 and/or the autonomous vehicle 102 via one or more communications networks including the communications network 108. The communications network 108 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the autonomous vehicle 102.

Each of the one or more remote computing devices 106 can include one or more processors and one or more memory devices. The one or more memory devices can be used to store instructions that when executed by the one or more processors of the one or more remote computing devices 106 cause the one or more processors to perform operations and/or functions including operations and/or functions associated with the autonomous vehicle 102 including exchanging (e.g., sending and/or receiving) data or signals with the autonomous vehicle 102, monitoring the state of the autonomous vehicle 102, and/or controlling the autonomous vehicle 102. The one or more remote computing devices 106 can communicate (e.g., exchange data and/or signals) with one or more devices including the operations computing system 104 and the autonomous vehicle 102 via the communications network 108.

The one or more remote computing devices 106 can include one or more computing devices (e.g., a desktop computing device, a laptop computing device, a smart phone, and/or a tablet computing device) that can receive input or instructions from a user or exchange signals or data with an item or other computing device or computing system (e.g., the operations computing system 104). Further, the one or more remote computing devices 106 can be used to determine and/or modify one or more states of the autonomous vehicle 102 including a location (e.g., latitude and longitude), a velocity, acceleration, a trajectory, and/or a path of the autonomous vehicle 102 based in part on signals or data exchanged with the autonomous vehicle 102. In some implementations, the operations computing system 104 can include the one or more remote computing devices 106.

The autonomous vehicle 102 can be a ground-based vehicle (e.g., an automobile, bike, scooter, other light electric vehicle, etc.), an aircraft, and/or another type of vehicle. The autonomous vehicle 102 can perform various actions including driving, navigating, and/or operating, with minimal and/or no interaction from a human driver. The autonomous vehicle 102 can be configured to operate in one or more modes including, for example, a fully autonomous operational mode, a semi-autonomous operational mode, a park mode, and/or a sleep mode. A fully autonomous (e.g., self-driving) operational mode can be one in which the autonomous vehicle 102 can provide driving and navigational operation with minimal and/or no interaction from a human driver present in the vehicle. A semi-autonomous operational mode can be one in which the autonomous vehicle 102 can operate with some interaction from a human driver present in the vehicle. Park and/or sleep modes can be used between operational modes while the autonomous vehicle 102 performs various actions including waiting to provide a subsequent vehicle service, and/or recharging between operational modes.

An indication, record, and/or other data indicative of the state of the vehicle, the state of one or more passengers of the vehicle, and/or the state of an environment including one or more objects (e.g., the physical dimensions and/or appearance of the one or more objects) can be stored locally in one or more memory devices of the autonomous vehicle 102. Additionally, the autonomous vehicle 102 can provide data indicative of the state of the vehicle, the state of one or more passengers of the vehicle, and/or the state of an environment to the operations computing system 104, which can store an indication, record, and/or other data indicative of the state of the one or more objects within a predefined distance of the autonomous vehicle 102 in one or more memory devices associated with the operations computing system 104 (e.g., remote from the vehicle). Furthermore, the autonomous vehicle 102 can provide data indicative of the state of the one or more objects (e.g., physical dimensions and/or appearance of the one or more objects) within a predefined distance of the autonomous vehicle 102 to the operations computing system 104, which can store an indication, record, and/or other data indicative of the state of the one or more objects within a predefined distance of the autonomous vehicle 102 in one or more memory devices associated with the operations computing system 104 (e.g., remote from the vehicle).

The autonomous vehicle 102 can include and/or be associated with the vehicle computing system 112. The vehicle computing system 112 can include one or more computing devices located onboard the autonomous vehicle 102. For example, the one or more computing devices of the vehicle computing system 112 can be located on and/or within the autonomous vehicle 102. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the autonomous vehicle 102 (e.g., its computing system, one or more processors, and other devices in the autonomous vehicle 102) to perform operations and functions, including those described herein.

As depicted in FIG. 1, the vehicle computing system 112 can include one or more autonomy system sensors 114, the positioning system 118, the autonomy computing system 120, the communication system 136, the vehicle control system(s) 138, and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more autonomy system sensors 114 can be configured to generate and/or store data including the autonomy system sensor data 116 associated with one or more objects that are proximate to the autonomous vehicle 102 (e.g., within range or a field of view of one or more of the one or more sensors 114). The one or more autonomy system sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy system sensor data 116 can include image data, radar data, LIDAR data, and/or other data acquired by the one or more autonomy system sensors 114. The one or more objects can include, for example, pedestrians, vehicles, bicycles, and/or other objects. The one or more sensors can be located on various parts of the autonomous vehicle 102 including a front side, rear side, left side, right side, top, or bottom of the autonomous vehicle 102. The autonomy system sensor data 116 can be indicative of locations associated with the one or more objects within the surrounding environment of the autonomous vehicle 102 at one or more times. For example, autonomy system sensor data 116 can be indicative of one or more LIDAR point clouds associated with the one or more objects within the surrounding environment. The one or more autonomy system sensors 114 can provide the autonomy system sensor data 116 to the autonomy computing system 120.

In addition to the autonomy system sensor data 116, the autonomy computing system 120 can retrieve or otherwise obtain data including the map data 122. The map data 122 can provide detailed information about the surrounding environment of the autonomous vehicle 102. For example, the map data 122 can provide information regarding: the identity and location of different roadways, road segments, buildings, or other items or objects (e.g., lampposts, crosswalks and/or curb), the location and directions of traffic lanes (e.g., the location and direction of a parking lane, a turning lane, a bicycle lane, or other lanes within a particular roadway or other travel way and/or one or more boundary markings associated therewith), traffic control data (e.g., the location and instructions of signage, traffic lights, or other traffic control devices), and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the autonomous vehicle 102. The positioning system 118 can be any device or circuitry for analyzing the position of the autonomous vehicle 102. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the autonomous vehicle 102 can be used by various systems of the vehicle computing system 112 and/or provided to one or more remote computing devices (e.g., the operations computing system 104 and/or the remote computing device 106). For example, the map data 122 can provide the autonomous vehicle 102 relative positions of the surrounding environment of the autonomous vehicle 102. The autonomous vehicle 102 can identify its position within the surrounding environment (e.g., across six axes) based at least in part on the data described herein. For example, the autonomous vehicle 102 can process the autonomy system sensor data 116 (e.g., LIDAR data, camera data) to match it to a map of the surrounding environment to get an understanding of the vehicle's position within that environment (e.g., transpose the autonomous vehicle's 102 position within its surrounding environment).

The autonomy computing system 120 can include a perception system 124, a prediction system 126, a motion planning system 128, and/or other systems that cooperate to perceive the surrounding environment of the autonomous vehicle 102 and determine a motion plan for controlling the motion of the autonomous vehicle 102 accordingly. In some examples, many of the functions performed by the perception system 124, prediction system 126, and motion planning system 128 can be performed, in whole or in part, by a single structured machine-learning model. Thus, the functions described below with regards to the perception system 124, the prediction system 126, and the motion planning system 128 can be performed by one or more structured machine-learned models even if the descriptions below do not specifically discuss a machine-learned model.

As an example, the autonomy computing system 120 can receive the autonomy system sensor data 116 from the one or more autonomy system sensors 114, attempt to determine the state of the surrounding environment by performing various processing techniques on the autonomy system sensor data 116 (and/or other data), and generate an appropriate motion plan through the surrounding environment. In some examples, the autonomy computing system 120 can use the sensor data 116 as input to a structured machine-learned model that can detect objects within the sensor data 116, forecast future motion of those objects, and select an appropriate motion plan for the autonomous vehicle 102. The structured machine-learned model can be included within one system and/or share one or more computing resources. In addition, or alternatively, portions of the structured machine-learned model can be included in one or more separate systems such as, for example, the perception system 124, the prediction system 126, and/or the motion planning system 128 of the autonomy system 120. In this manner, the autonomy computing system 120 can obtain a motion plan and control the one or more vehicle control system(s) 138 to operate the autonomous vehicle 102 according to the motion plan.

As another example, the perception system 124 can identify one or more objects that are proximate to the autonomous vehicle 102 based on autonomy system sensor data 116 received from the autonomy system sensors 114. In particular, in some implementations, the perception system 124 can determine, for each object, state data 130 that describes the current state of such object. As examples, the state data 130 for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine state data 130 for each object over a number of iterations. In particular, the perception system 124 can update the state data 130 for each object at each iteration. Thus, the perception system 124 can detect and track objects (e.g., vehicles, bicycles, pedestrians, etc.) that are proximate to the autonomous vehicle 102 over time, and thereby produce a presentation of the world around a vehicle 102 along with its state (e.g., a presentation of the objects of interest within a scene at the current time along with the states of the objects).

The prediction system 126 can receive the state data 130 from the perception system 124 and predict one or more future locations and/or moving paths for each object based on such state data. For example, the prediction system 126 can generate prediction data 132 associated with each of the respective one or more objects proximate to vehicle 102. The prediction data 132 can be indicative of one or more predicted future locations of each respective object. The prediction data 132 can be indicative of a predicted path (e.g., predicted trajectory) of at least one object within the surrounding environment of the autonomous vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the autonomous vehicle 102 based at least in part on the prediction data 132 (and/or other data). The motion plan data 134 can include vehicle actions with respect to the objects proximate to the autonomous vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the autonomous vehicle 102 can perform a certain action (e.g., pass an object) without increasing the potential risk to the autonomous vehicle 102 and/or violating any traffic laws (e.g., speed limits, lane boundaries, signage). The motion plan data 134 can include a planned trajectory, velocity, acceleration, and/or other actions of the autonomous vehicle 102.

As one example, in some implementations, the motion planning system 128 can determine a cost function for each of one or more candidate motion plans for the autonomous vehicle 102 based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle 102 approaches impact with another object and/or deviates from a preferred pathway (e.g., a predetermined travel route).

Thus, given information about the current locations and/or predicted future locations and/or moving paths of objects, the motion planning system 128 can determine a cost of adhering to a particular candidate pathway. The motion planning system 128 can select or determine a motion plan for the autonomous vehicle 102 based at least in part on the cost function(s). For example, the motion plan that minimizes the cost function can be selected or otherwise determined. The motion planning system 128 then can provide the selected motion plan to a vehicle control system 138 that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the autonomous vehicle 102.

The vehicle computing system 112 can include a communications system 136 configured to allow the vehicle computing system 112 (and it's one or more computing devices) to communicate with other computing devices. The vehicle computing system 112 can use the communications system 136 to communicate with the operations computing system 104 and/or one or more other remote computing devices (e.g., the one or more remote computing devices 106) over one or more networks (e.g., via one or more wireless signal connections, etc.). In some implementations, the communications system 136 can allow communication among one or more of the systems on-board the autonomous vehicle 102. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop, and/or smartphone) can be viewable by a user of the autonomous vehicle 102 that is located in the front of the autonomous vehicle 102 (e.g., driver's seat, front passenger seat). Additionally, or alternatively, a display device can be viewable by a user of the autonomous vehicle 102 that is located in the rear of the autonomous vehicle 102 (e.g., a passenger seat in the back of the vehicle).

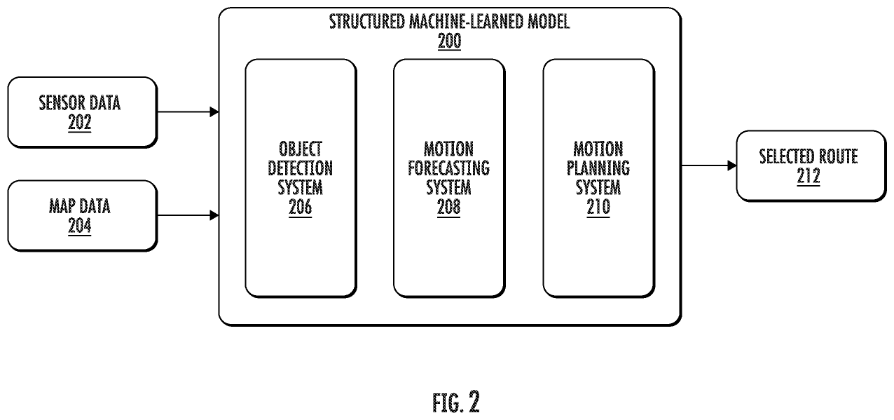

FIG. 2 depicts a block diagram of a model 200 for generating routes using a machine-learned model according to example embodiments of the present disclosure. In some examples, a structured model 200 can include one or more components. Each component (e.g., 206, 208, 210) can output an intermediate representation of data that can be used as input to the next component in the structured model 200 until the final component outputs a selected route 212. The structured model 200 can include an object detection system 206, a motion forecasting system 208, and a motion planning system 210.

The structured model 200 can take sensor data 202 and map data 204 as input. The sensor data 202 can include LIDAR point cloud data representing information about one or more objects in the environment around an autonomous vehicle (e.g., autonomous vehicle 102 in FIG. 1). The LIDAR point cloud data can be obtained by one or more sensors (e.g., sensor(s) 114 in FIG. 1) such as, for example, a LIDAR sensor. Map data 204 can include data representing one or more features of a geographic area nearby the autonomous vehicle (e.g., autonomous vehicle 102 in FIG. 1). The map data 204 can be high definition map data that includes data about one or more permanent features of the geographic area including but not limited to roadways, buildings, obstacles, traffic signs, and/or any applicable laws or traffic rules.

The object detection system 206 can analyze the sensor data 202 to identify one or more objects in the environment of the autonomous vehicle (e.g., autonomous vehicle 102 in FIG. 1). The object detection system 206 (or another component of the structured model 200) can convert the sensor data 202 into a three-dimensional tensor representation. Using this intermediate representation of the sensor data 202 as input to the object detection system 206, the structured machine-learned model 200 can detect one or more objects (e.g., other vehicles, pedestrians, bicyclists, and so on) in the area around the autonomous vehicle (e.g., autonomous vehicle 102 in FIG. 1) and output an intermediate representation that includes data describing the position, size, and heading of the one or more detected objects. This information can be included in a detection header.

The intermediate representation (e.g., a detection header) of the one or more detected objects can be used as input to the motion forecasting system 208 of the structured machine-learned model 200. This intermediate representation can include data describing the location of one or more objects (e.g., actors) and their initial velocities. The motion forecasting system 208 can use the detection header to predict how the one or more objects could potentially behave in the one or more future time steps (e.g., one or more seconds, one or more minutes, etc.). More specifically, the motion forecasting system 208 can model the joint distribution of the intermediate representation (the position and velocity of the object(s)) to capture the dependencies between all the objects and produce a probabilistic multimodal output.

The probabilistic multimodal output can include another intermediate representation describing the predicted movement of one or more objects (or actors) in the area around the autonomous vehicle (e.g., autonomous vehicle 102 in FIG. 1). For example, the predicted movement of the one or more object (or actors) can be defined as one or more potential trajectories for a given object of the one or more objects. More specifically, each potential trajectory for a given object can have an associated likelihood that the object will travel along that trajectory. Once data describing the probabilities associated with different potential trajectories of the other objects is generated, the motion planning system 210 can accept, as input, the current position, direction, and destination of the autonomous vehicle (e.g., autonomous vehicle 102 in FIG. 1). Based on this information, the motion planning system 210 of structured machine-learned model 200 can generate one or more candidate trajectories for the autonomous vehicle (e.g., autonomous vehicle 102 in FIG. 1). Each candidate trajectory can be evaluated to generate a unary cost for the trajectory. The unary cost can reflect the estimated cost (where a lower cost is better) associated with each candidate vehicle trajectory. Once the unary cost has been generated, it can be combined with the probabilistic representations of the trajectories of other objects to generate a pairwise cost (e.g., using the likely positions and trajectories of the other actors in the area to determine which trajectories are more likely to result in the desired outcome) for each candidate trajectory for the autonomous vehicle (e.g., autonomous vehicle 102 in FIG. 1).

The structured machine-learned model 200 can produce a pairwise cost for each candidate vehicle trajectory. The candidate vehicle trajectory with the lowest pair-wise cost can be selected and transmitted to the vehicle control systems (e.g., vehicle control systems 138 in FIG. 1) of the autonomous vehicle (e.g., autonomous vehicle 102 in FIG. 1) for implementation. Thus, autonomous vehicles (e.g., autonomous vehicle 102 in FIG. 1) can include this structured machine-learned model 200 to provide safe, reliable trajectory selection from a single machine-learned model.

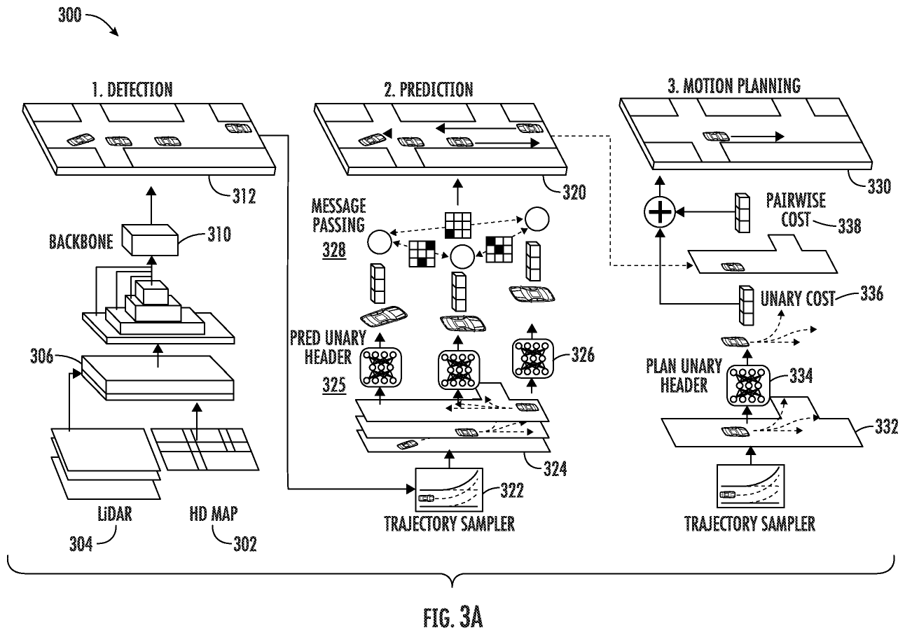

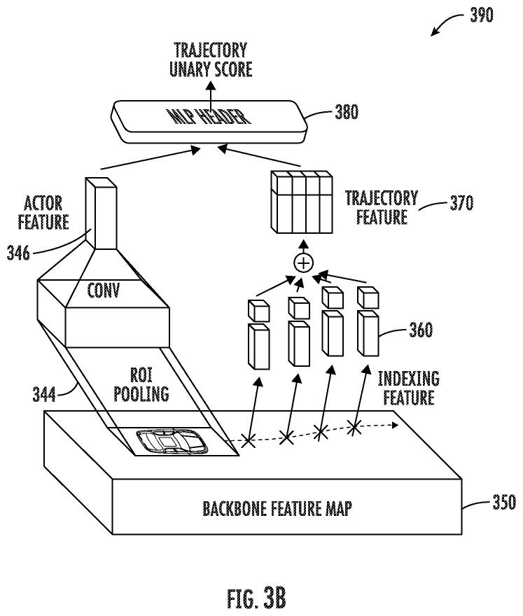

FIG. 3A depicts a diagram of a structured machine-learned model 300 according to example embodiments of the present disclosure. The structured machine-learned model 300 can include a backbone network 310. The backbone network 310 can take raw sensor data as input in the form of LiDAR point clouds 304 and a high-definition map 302 for the area near the autonomous vehicle (e.g., autonomous vehicle 102 in FIG. 1).

In some examples, the backbone network 310 can receive LiDAR data 304 for a plurality of consecutive time steps (e.g., a plurality of sweeps from a plurality of time steps that occur in order (e.g., one or more seconds (e.g., t=1 s, 2 s, etc.), minutes (t=1 m, 2 m, etc.), etc.). For example, the backbone network 310 can receive LiDAR data 304 during ten consecutive LiDAR sweeps (instances in which LiDAR gathers data). Each LiDAR sweep, for example, can include LiDAR point cloud data at a respective time step such that each consecutive LiDAR sweep can include LiDAR data at one or more time steps subsequent to a current time step. The LiDAR data 304 from each sweep can be transformed into a form such that the data included therein follows a coordinate system that represents the location of the data relative to the autonomous vehicle (e.g., autonomous vehicle 102 in FIG. 1). This coordinate system may be referred to as an ego-coordinate system.

In some examples, the LiDAR point cloud data 304 can be processed to generate a voxelized representation 306 of the LiDAR point cloud data 304. A voxelized representation 306 of an area can be a representation in which the three-dimensional space is divided up into a plurality of equally sized sub-spaces. Each sub-space can be represented by a data value in a data structure.

The backbone network 310 can create the voxelized representation 306 with a three-dimensional occupancy tensor for the plurality of LiDAR sweeps. For each sweep, the backbone network 310 can generate a three-dimensional occupancy tensor for each location in the area represented. Thus, each sub-space (represented by a particular voxel) in the three-dimensional space can have an associated binary value for each time period representing whether the three-dimensional space includes a point in the point cloud data during that time period. As an object moves through the three-dimensional space, the occupancy values associated with a particular sub-space can vary.

The tensors for each of the plurality of sweeps can be concatenated along the height dimension. Doing so can result in a three-dimensional tensor (e.g., a time dimension added to the existing tensor data).

The high definition maps 302 can also be used as strong signals for detection, prediction, and planning as autonomous vehicles (e.g., autonomous vehicle 102 in FIG. 1) typically follow the rules of traffic (e.g., to comply with road restrictions while traveling on a road). The backbone network 310 of the structured machine-learned model 300 can rasterize one or more lanes within the high definition maps 302 with different semantics (e.g., straight, turning, blocked by a traffic light) into different channels and concatenate them with the three-dimensional tensor to form a representation of the sensor input.

As such, the representation produced as a result of the above transformation of the LiDAR data 304 and high definition map data 302 can be formatted as a three-dimensional tensor X∈ [symbol] ^{C×W×H}, where W and H are the width and height, and C is the total number of channels for both the LiDAR data 304 and high definition map data 302.

This representation can be used as input to the next portion of the machine-learned model 300 to detect one or more objects (e.g., actors) in the area. An object may be another vehicle, pedestrian, bike, or another object capable of movement. In addition, the machine-learned model 300 can predict the location and velocity of each detected object. This information can be integrated into a representation of the area and stored in a detection header 312. The detection header 312 can include two layers, one layer for classification and one layer for regression.

The classification layer can include a plurality of classification scores, one for each location within the space represented by the data produced by the machine-learned model 300. The classification score for a location can represent the likelihood that an object is present at the location. The regression layer can include the offset values at each location. These offset values include position offset, size, heading angle, and velocity. The two layers can be used in concert to determine the bounding boxes for all objects and their initial speeds.

Using the location and initial speeds for each object, the prediction portion of the machine-learned model 300 can predict how each object could potentially behave in the near future (e.g., a few seconds into the future). The structured machine-learned model 300 can generate a joint distribution of all objects' future behavior to capture the dependencies among all objects and produce probabilistic multi-modal outputs. More specifically, the machine-learned model 300 can initially generate a plurality of candidate future trajectories 322.

Formally, let sᵢ be the candidate future trajectory of the i-th object, and let S={sᵢ}_{i=1, . . . , N} be the set of candidate trajectories 322 for all objects in the scene. A candidate trajectory can be represented as a set of two-dimensional coordinates at fixed discrete future timestamps, e.g., 1 s, 2 s, 3 s. The motion forecasting system 320 can generate (at 326), for each candidate trajectory 322, a likelihood value of that object following the trajectory. In some examples, the likelihood value can include the “goodness” of a given trajectory for that object. Goodness can represent the degree to which the trajectory could feasibly be accomplished in the real world or the unary potential of a given path. For example, the likelihood value can be generated based on modeling the physical dynamics and traffic-rules of the area and the object. For example, turning sharply with high speed in front of a red light is not very likely to happen in the real world.

To ensure that the structured machine-learned model 300 can efficiently and quickly analyze a large number of candidate trajectories (e.g., have a high model capacity), the motion forecasting system 320 can include a deep neural network to construct the likelihood values for each candidate trajectory. Given a candidate future trajectory sᵢ for the i-th object, the motion forecasting system 320 can extract its feature representation by indexing the corresponding locations from the backbone feature map. Specifically, based on the detected bounding box of the i-th object, the motion forecasting system 320 can apply region of interest (ROI) pooling to the backbone feature map followed by several convolution layers to compute the object's feature data. Note that the backbone feature data used to compute the object's feature data can be generated by the backbone network 310 during the detection step 312. The feature data can encode rich information about the environment.

The motion forecasting system can use the same procedure to get the feature representation for every candidate trajectory and concatenate them together with (xₜ; yₜ; cos(θₜ), sin(θₜ), distanceₜ) to form the trajectory feature 324. The object feature data (e.g., based on data about the object) and the trajectory feature data (e.g., based on information about the trajectory) can be used as input to the multilayer perceptron 326. The output of a multi-layer perceptron (MLP) can be a likelihood score for each of the plurality of trajectories. Finally, the object and trajectory features can be fed into an MLP 326 to construct the likelihood value (or unary score) for the trajectory.

Once a unary score (stored in a predicted unary header 325) is determined for the plurality of trajectories, the motion prediction module 320 can, through a message-passing step 328, generate an updated likelihood value (or pairwise score) that measures the consistency between two different objects' behaviors given the scene, (e.g., whether trajectory sᵢ collides with sⱼ). In some examples, likelihood scores can be updated by detecting collisions between two actors or objects when they execute their trajectories. In other examples, this adjustment can be determined using a learnable deep neural network.

The structured model 300 can use the output(s) from the detection stage 312 and prediction stage 320 of the machine-learned model 300 to generate a route for the autonomous vehicle (e.g., autonomous vehicle 102 in FIG. 1). For example, a route can describe a specific path for the autonomous vehicle (e.g., autonomous vehicle 102 in FIG. 1) to travel from a current location to a destination location. A motion planning system 330 in the structured machine-learned model 300 can generate candidate trajectories for the autonomous vehicle (e.g., autonomous vehicle 102 in FIG. 1) to follow as it traverses the route. Each candidate trajectory can be executable by the autonomous vehicle (e.g., autonomous vehicle 102 in FIG. 1). A candidate trajectory can be executable if it is feasible for the vehicle control systems (e.g., vehicle control systems 138 in FIG. 1) to implement. Each trajectory can be generated to comprise a specific amount of travel time (e.g., eight seconds or another amount of time).

The motion planning system 330 can be used to generate a trajectory going forward towards a goal while avoiding collision with other objects. A plurality of candidate trajectories 332 can be generated and evaluated to determine which candidate trajectory will be the most advantageous for the autonomous vehicle (e.g., autonomous vehicle 102 in FIG. 1). For example, the following formula can be used to determine the cost for a given trajectory.

$$C ( τ , X ) = {C}_{u} ( τ , X ) + {𝔼}_{Pw ( s \vert x )} [ {\sum }_{i = 1}^{N} {C}_{pa} ( τ , {s}_{i} , X ) ]$$

where Cᵤ and Cₚₐ are the unary and pairwise cost functions respectively. The unary cost 336 can evaluate how well a trajectory follows the autonomous vehicle's (e.g., autonomous vehicle 102 in FIG. 1) dynamic behavior, goal-oriented progress, and traffic rules. The vehicle features and trajectory features can be extracted from the backbone network 310. The motion planning system 330 can use a separate MLP 334 to compute a scalar value for the unary cost 336. Once the unary cost 336 is calculated, the motion planning system 330 can calculate the pairwise cost that explicitly models the interaction (e.g., social interactions or vehicular interactions) between the autonomous vehicle (e.g., autonomous vehicle 102 in FIG. 1) and other objects' motion, e.g., how likely two cars are to collide, whether one should yield to others, etc. Thus, the final pairwise cost 338 can include a representation of factors associated with the autonomous vehicle (e.g., autonomous vehicle 102 in FIG. 1) and its environment and the uncertainty in predicting the motion of other objects in the area. The model can then select a particular trajectory based on the calculated pairwise cost 338.

FIG. 3B depicts a diagram of a system 390 for generating a trajectory unary score according to example embodiments of the present disclosure. This system can machine-learned model(s) such as, for example, those described herein. In this example, the unary score is generated by accessing data in a backbone feature map 350. The machine-learned model can use region of interest pooling 344 to extract one or more actor features 346 based on one or more characteristics of the autonomous vehicle (e.g., autonomous vehicle 102 in FIG. 1). The trajectory being evaluated can be represented as a series of points at a series of time steps. The machine-learned model can extract feature data 360 for each point in the trajectory. This feature data can be concatenated to generate trajectory feature data 370. The actor feature data and the trajectory feature data can be used as input into a multi-layer perceptron (MLP). The MLP can produce a unary score for the trajectory and store it in an MLP header 380.

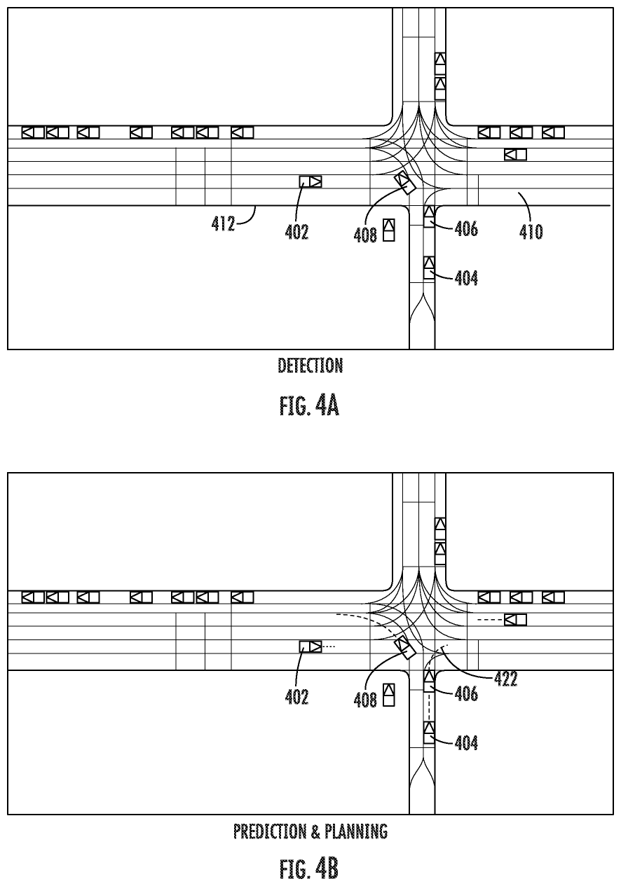

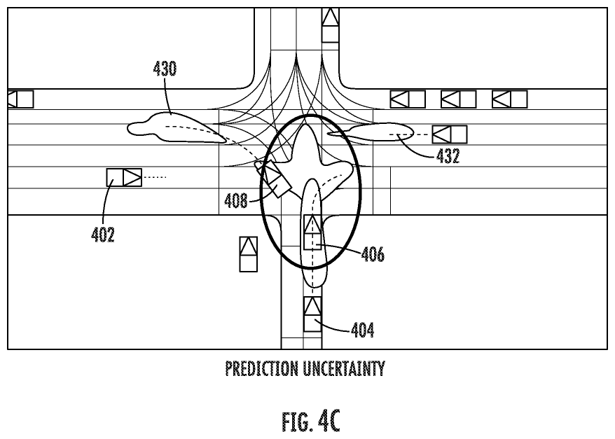

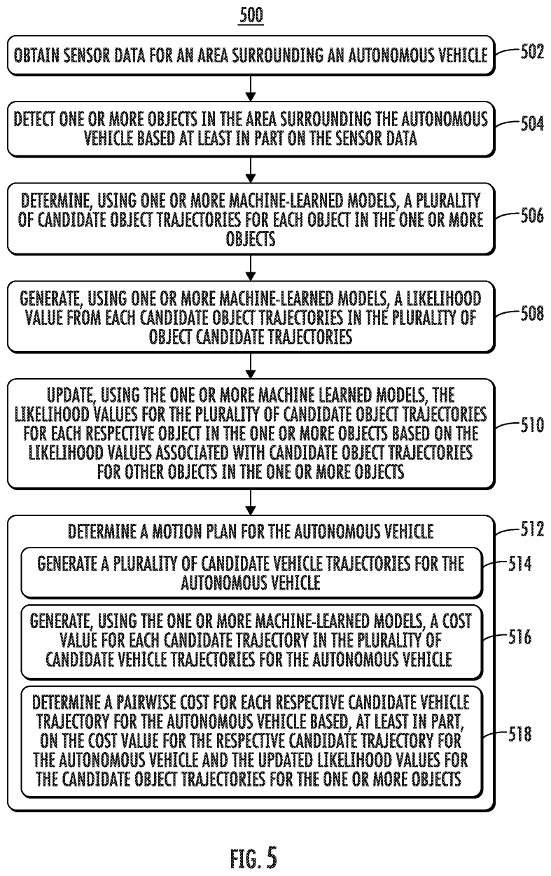

FIG. 4A depicts an example detection map according to example embodiments of the present disclosure. This example map can be generated by analyzing sensor data as part of the detection step. The map includes an autonomous vehicle 402 (e.g., the ego car), a plurality of objects (e.g., 404, 406, 408), and road features (e.g., lanes 410, boundaries 412, obstacles).

FIG. 4B depicts example prediction and planning data according to example embodiments of the present disclosure. The example prediction and planning data can represent the potential trajectories (e.g., 420 and 422) of one or more objects (e.g., 404, 406, 408) within the area of the autonomous vehicle 402. This example map can be generated as part of the motion forecasting step.

FIG. 4C depicts example prediction uncertainty data according to example embodiments of the present disclosure. The example prediction uncertainty data can include data representing the likely positions (e.g., 430 and 432) on one or more objects (e.g., 404, 406, 408) within the area of the autonomous vehicle 402. This example map can be generated as part of the motion planning step.

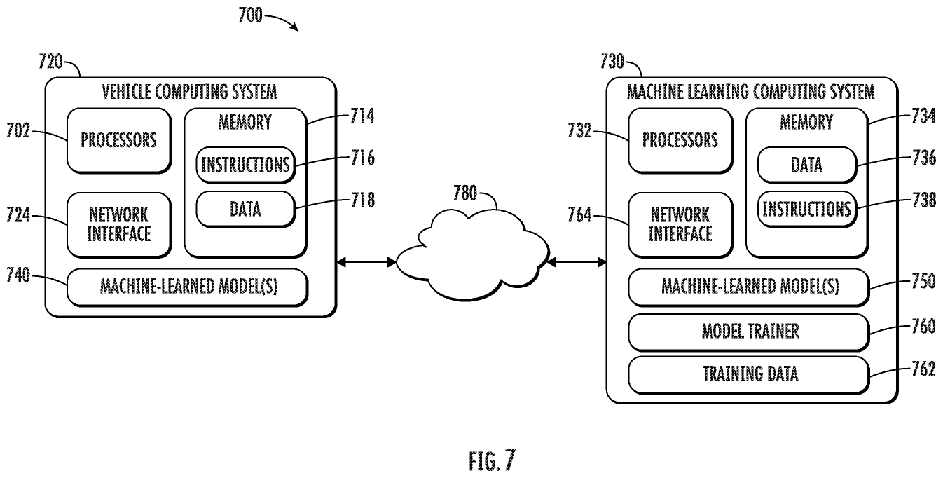

FIG. 5 depicts a flow chart diagram of an example method 500 according to example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1 and 7.

An autonomous vehicle can travel through a particular three-dimensional space. The autonomous vehicle can include one or more sensors. A structured machine-learned model (e.g., structured machine-learned model 200 in FIG. 2, 300 in FIG. 3, etc.) can, at 502, obtain sensor data for an area around an autonomous vehicle. In some examples, the machine-learned model (e.g., structured machine-learned model 200 in FIG. 2, 300 in FIG. 3, etc.) can be a structured network that includes a plurality of subsections with each subsection producing an interpretable intermediate representation.

In some examples, the structured machine-learned model (e.g., structured machine-learned model 200 in FIG. 2) can process the sensor data to produce a first intermediate representation of the area around the autonomous vehicle (e.g., autonomous vehicle 102 in FIG. 1). Producing the first intermediate representation of the area around the autonomous vehicle (e.g., autonomous vehicle 102 in FIG. 1) can include, for example, generating, using the machine-learned model (e.g., structured machine-learned model 200 in FIG. 2), a plurality of voxelized representations of the sensor data at a plurality of time steps.

Each voxel can include a binary value indicating whether the voxel includes a LIDAR point. The structured machine-learned model (e.g., structured machine-learned model 200 in FIG. 2) can concatenate the voxelized representation of the sensor data at a plurality of time steps to generate a three-dimensional tensor representation of the sensor data.

The structured machine-learned model (e.g., structured machine-learned model 200 in FIG. 2) can detect, at 504, one or more objects in the area around the autonomous vehicle (e.g., autonomous vehicle 102 in FIG. 1) based at least in part on the sensor data. The objects can include actors such as vehicles, pedestrians, bicyclists, and any other moving objects. The detected objects can be included in a first intermediate representation that includes data describing one or more features of the object including the location of the object, the size of the object, the current velocity, heading, etc.

The structured machine-learned model (e.g., structured machine-learned model 200 in FIG. 2) can determine, at 506, a plurality of candidate object trajectories for each object in the one or more objects. Each trajectory can be represented as a series of coordinates for a series of time steps (e.g., 1 second, 2 seconds, 3 seconds, and so on). For each respective object in the one or more objects, the structured machine-learned model (e.g., structured machine-learned model 200 in FIG. 2) can generate likelihood data for each candidate object trajectory in the plurality of candidate object trajectories.

The structured machine-learned model (e.g., structured machine-learned model 200 in FIG. 2) can, for each object in the one or more objects, determine feature data for the object. The structured machine-learned model (e.g., structured machine-learned model 200 in FIG. 2) can determine trajectory feature data for each candidate trajectory. The plurality of candidate object trajectories can be used as input to one section of the structured machine-learned model. Using the plurality of candidate object trajectories as input, the structured machine-learned model (e.g., structured machine-learned model 200 in FIG. 2) can generate as output, at 508 likelihood data for each candidate object trajectory in the plurality of candidate object trajectories. This represents an inference step in the structured machine-learned model (e.g., using candidate object trajectories as input to the model and receiving likelihood data as output of the model). The likelihood data can include a likelihood distribution for the plurality of candidate object trajectories. In some examples, the likelihood data can involve discrete likelihood values for each candidate object trajectory. The object feature data can represent data determined based on region of interest pooling. Trajectory feature data associated with an object or actor can include the coordinates of the object at a sequence of timestamps. This information can represent the path of the trajectory over time.

In some examples, the likelihood data can represent the goodness of the trajectory or the likelihood that the object will move along that trajectory. In some examples, the structured machine-learned model (e.g., structured machine-learned model 200 in FIG. 2) can provide environmental feature data as input to a motion forecasting module.

The likelihood data for all the one or more objects can be used as input to the structured machine-learned model. Using the likelihood data as input, the structured machine-learned model (e.g., structured machine-learned model 200 in FIG. 2) can determine, at 510, the updated likelihood data for the plurality of candidate object trajectories for each respective object in the one or more objects based on the likelihood data associated with candidate object trajectories for other objects in the one or more objects. The structured machine-learned model (e.g., structured machine-learned model 200 in FIG. 2) can generate updated likelihood data at least in part based on a message-passing stage in which the likelihood data for a respective plurality of candidate object trajectories associated with the respective object are compared to likely trajectories of one or more other candidates.

The structured machine-learned model (e.g., structured machine-learned model 200 in FIG. 2) can generate, at 514, a plurality of candidate vehicle trajectories for the autonomous vehicle (e.g., autonomous vehicle 102 in FIG. 1). The trajectories can be determined based on the original position of the object, the original velocity of the object, high definition map data, legal considerations, pass trajectory information, and so on. The structured machine-learned model (e.g., structured machine-learned model 200 in FIG. 2) can generate, at 516, a cost value for each candidate trajectory in the plurality of candidate vehicle trajectories for the autonomous vehicle (e.g., autonomous vehicle 102 in FIG. 1). The cost value for each candidate trajectory for the autonomous vehicle (e.g., autonomous vehicle 102 in FIG. 1) can be a unary cost value.

The unary cost value can be generated by using feature data associated with the autonomous vehicle and feature data associated with one or more candidate vehicle trajectories as input to a motion planning module of the structured machine-learned model (e.g., structured machine-learned model 200 in FIG. 2). In some examples, the structured machine-learned model (e.g., structured machine-learned model 200 in FIG. 2) can provide environmental feature data as input to the motion forecasting module. The environmental feature data can indicate, for example, the position of unmoving obstacles (e.g., trees or road barriers), data describing current environmental conditions (e.g., road surface conditions), data describing the geographic features of the area (e.g., the slope of the current road), etc.

The structured machine-learned model (e.g., structured machine-learned model 200 in FIG. 2) can determine, at 518, a pairwise cost for each respective candidate vehicle trajectory for the autonomous vehicle (e.g., autonomous vehicle 102 in FIG. 1) based, at least in part, on the cost value for the respective candidate trajectory for the autonomous vehicle and the updated likelihood values for the candidate object trajectories for the one or more objects. The structured machine-learned model (e.g., structured machine-learned model 200 in FIG. 2) can select a trajectory with the lowest calculated cost. The trajectory can be transmitted to the vehicle controller for use in controlling the autonomous vehicle.

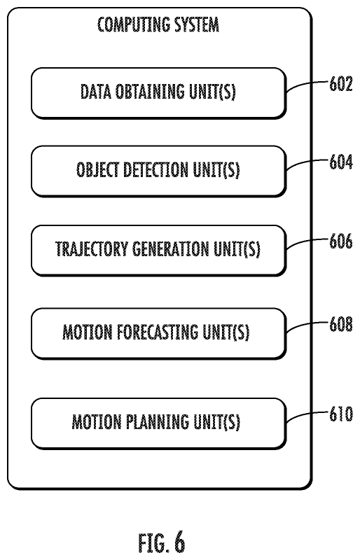

FIG. 6 depicts an example system with units for performing operations and functions according to example aspects of the present disclosure. Various means can be configured to perform the methods and processes described herein. For example, a computing system can include data obtaining unit(s) 602, object detection unit(s) 604, trajectory generation unit(s) 606, motion forecasting unit(s) 608, motion planning unit(s) 610, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain sensor data for an area around an autonomous vehicle. For example, a LIDAR sensor associated with an autonomous vehicle can capture point cloud data for a space around the autonomous vehicle and provide that data to a machine-learned model. A data obtaining unit 602 is one example of a means for obtaining sensor data for an area around an autonomous vehicle.

The means can be configured to detect one or more objects in the area around the autonomous vehicle based at least in part on the sensor data. A detection module can analyze the sensor data to identify the position and velocity of one or more objects in the area. This information can be stored as a detection header and provided to the model as input. An object detection unit 604 is one example of a means for detecting one or more objects in the area around the autonomous vehicle based at least in part on the sensor data.

The means can be configured to determine, using one or more machine-learned models, a plurality of candidate object trajectories for each object in the one or more objects. For example, the candidate object trajectory can be determined based on the current position and velocity of the object, high definition map data, and data describing legal considerations at the area of the object. A trajectory generation unit 606 is one example of a means for determining, using one or more machine-learned models, a plurality of candidate object trajectories for each object in the one or more objects.

The means can be configured to generate, using one or more machine-learned models, likelihood data for each candidate object trajectory in the plurality of candidate object trajectories and update, using the one or more machine learned models, the likelihood data for the plurality of candidate object trajectories for each respective object in the one or more objects based on the likelihood data associated with candidate object trajectories for other objects in the one or more objects. For example, the motion forecasting unit 608 can determine the likelihood that each candidate object trajectory will occur and then adjust those likelihood data based on the likely movement of the other objects. An motion forecasting unit 608 is one example of a means for generating, using one or more machine-learned models, likelihood data for each candidate object trajectory in the plurality of candidate object trajectories and generating, using the one or more machine learned models, updated likelihood data for the plurality of candidate object trajectories for each respective object in the one or more objects based on the likelihood data associated with candidate object trajectories for other objects in the one or more objects.

The means can be configured to determine a motion plan for the autonomous vehicle. For example, the motion planning module can generate a plurality of candidate vehicle trajectories for the autonomous vehicle, generate, using the one or more machine-learned models, a cost value for each candidate trajectory in the plurality of candidate vehicle trajectories for the autonomous vehicle, and determine a motion plan for the autonomous vehicle, based at least in part, on the updated likelihood values for the plurality of candidate object trajectories for each respective object. A motion planning unit 610 is one example of a means for determining a motion plan for the autonomous vehicle.

FIG. 7 depicts a block diagram of an example computing system 700 according to example embodiments of the present disclosure. The example system 700 includes a computing system 720 and a machine learning computing system 730 that are communicatively coupled over a network 770.

In some implementations, the computing system 720 can perform a method for using a structured machine-learned model to generate trajectories for an autonomous vehicle (e.g., autonomous vehicle 102 in FIG. 1). In some implementations, the computing system 720 can be included in an autonomous vehicle. For example, the computing system 720 can be on-board the autonomous vehicle. In other implementations, the computing system 720 is not located on-board the autonomous vehicle. For example, the computing system 720 can operate offline to use a structured machine-learned model to generate trajectories for an autonomous vehicle (e.g., autonomous vehicle 102 in FIG. 1). The computing system 720 can include one or more distinct physical computing devices.

The computing system 720 includes one or more processors 702 and a memory 704. The one or more processors 702 can be any suitable processing device (e.g., a processor core, a microprocessor, an ASIC, a FPGA, a controller, a microcontroller, etc.) and can be one processor or a plurality of processors that are operatively connected. The memory 704 can include one or more non-transitory computer-readable storage media, such as RAM, ROM, EEPROM, EPROM, one or more memory devices, flash memory devices, etc., and combinations thereof.

The memory 704 can store information that can be accessed by the one or more processors 702. For instance, the memory 704 (e.g., one or more non-transitory computer-readable storage mediums, memory devices) can store data 706 that can be obtained, received, accessed, written, manipulated, created, and/or stored. The data 706 can include, for instance, LIDAR point cloud data, high definition map data, trajectory likelihood values, and voxelized backbone network data, etc. as described herein. In some implementations, the computing system 720 can obtain data from one or more memory device(s) that are remote from the system 720.

The memory 704 can also store computer-readable instructions 708 that can be executed by the one or more processors 702. The instructions 708 can be software written in any suitable programming language or can be implemented in hardware. Additionally, or alternatively, the instructions 708 can be executed in logically and/or virtually separate threads on processor(s) 702.

For example, the memory 704 can store instructions 708 that when executed by the one or more processors 702 cause the one or more processors 702 to perform any of the operations and/or functions described herein, including, for example, obtaining sensor data for an area around an autonomous vehicle, detecting one or more objects based on the sensor data, determining a plurality of candidate object trajectories for each object in the one or more objects, generating, using one or more machine-learned models, a likelihood value for each candidate object trajectory in the plurality of candidate object trajectories, updating the likelihood values for each of the plurality of candidate object trajectories for each respective object in the one or more objects based on the likelihood values associated with candidate object trajectories for other objects in the one or more objects, and determining a motion plan for the autonomous vehicle.

According to an aspect of the present disclosure, the computing system 720 can store or include one or more machine-learned models 740. As examples, the machine-learned models 740 can be or can otherwise include various machine-learned models such as, for example, neural networks (e.g., deep neural networks), multi-layer perceptrons, support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks.

In some implementations, the computing system 720 can receive the one or more machine-learned models 740 from the machine learning computing system 730 over network 770 and can store the one or more machine-learned models 740 in the memory 704. The computing system 720 can then use or otherwise implement the one or more machine-learned models 740 (e.g., by processor(s) 702). In particular, the computing system 720 can implement the machine learned model(s) 740 to generate trajectories for an autonomous vehicle (e.g., autonomous vehicle 102 in FIG. 1).

The machine learning computing system 730 includes one or more processors 732 and a memory 734. The one or more processors 732 can be any suitable processing device (e.g., a processor core, a microprocessor, an ASIC, a FPGA, a controller, a microcontroller, etc.) and can be one processor or a plurality of processors that are operatively connected. The memory 734 can include one or more non-transitory computer-readable storage media, such as RAM, ROM, EEPROM, EPROM, one or more memory devices, flash memory devices, etc., and combinations thereof.

The memory 734 can store information that can be accessed by the one or more processors 732. For instance, the memory 734 (e.g., one or more non-transitory computer-readable storage mediums, memory devices) can store data 736 that can be obtained, received, accessed, written, manipulated, created, and/or stored. The data 736 can include, for instance, LIDAR point cloud data, high definition map data, trajectory likelihood value, and voxelized backbone network data as described herein. In some implementations, the machine learning computing system 730 can obtain data from one or more memory device(s) that are remote from the system 730.

The memory 734 can also store computer-readable instructions 738 that can be executed by the one or more processors 732. The instructions 738 can be software written in any suitable programming language or can be implemented in hardware. Additionally, or alternatively, the instructions 738 can be executed in logically and/or virtually separate threads on processor(s) 732.

For example, the memory 734 can store instructions 738 that when executed by the one or more processors 732 cause the one or more processors 732 to perform any of the operations and/or functions described herein, including, for example, obtaining sensor data for an area around an autonomous vehicle, detecting one or more objects based on the sensor data, determining a plurality of candidate object trajectories for each object in the one or more objects, generating, using one or more machine-learned models, a likelihood value for each candidate object trajectory in the plurality of candidate object trajectories, updating the likelihood values for each of the plurality of candidate object trajectories for each respective object in the one or more objects based on the likelihood values associated with candidate object trajectories for other objects in the one or more objects, and determining a motion plan for the autonomous vehicle

In some implementations, the machine learning computing system 730 includes one or more server computing devices. If the machine learning computing system 730 includes multiple server computing devices, such server computing devices can operate according to various computing architectures, including, for example, sequential computing architectures, parallel computing architectures, or some combination thereof.

In addition or alternatively to the model(s) 740 at the computing system 720, the machine learning computing system 730 can include one or more machine-learned models 750. As examples, the machine-learned models 750 can be or can otherwise include various machine-learned models such as, for example, neural networks (e.g., deep neural networks), support vector machines, decision trees, ensemble models, k-nearest neighbors models, multi-layer perceptrons, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks.

As an example, the machine learning computing system 730 can communicate with the computing system 720 according to a client-server relationship. For example, the machine learning computing system 750 can implement the machine-learned models 750 to provide a web service to the computing system 720. For example, the web service can provide support to an autonomous vehicle.

Thus, machine-learned models 740 can be located and used at the computing system 720 and/or machine-learned models 750 can be located and used at the machine learning computing system 730.

In some implementations, the machine learning computing system 730 and/or the computing system 720 can train the machine-learned models 740 and/or 750 through use of a model trainer 760. The model trainer 760 can train the machine-learned models 740 and/or 750 using one or more training or learning algorithms. One example training technique is backwards propagation of errors. In some implementations, the model trainer 760 can perform supervised training techniques using a set of labeled training data. In other implementations, the model trainer 760 can perform unsupervised training techniques using a set of unlabeled training data. The model trainer 760 can perform a number of generalization techniques to improve the generalization capability of the models being trained. Generalization techniques include weight decays, dropouts, or other techniques.

In particular, the model trainer 760 can train a machine-learned model 740 and/or 750 based on a set of training data 762. The training data 762 can include, for example, data associated with the predicting the paths of actors in an environment based on sensor data and map data. The model trainer 760 can be implemented in hardware, firmware, and/or software controlling one or more processors.

The computing system 720 can also include a network interface 724 used to communicate with one or more systems or devices, including systems or devices that are remotely located from the computing system 720. The network interface 724 can include any circuits, components, software, etc. for communicating with one or more networks (e.g., 770). In some implementations, the network interface 724 can include, for example, one or more of a communications controller, receiver, transceiver, transmitter, port, conductors, software and/or hardware for communicating data. Similarly, the machine learning computing system 730 can include a network interface 764.

The network(s) 770 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 770 can be accomplished, for instance, via a network interface using any type of protocol, protection scheme, encoding, format, packaging, etc.

Computing tasks discussed herein as being performed at computing device(s) remote from the autonomous vehicle can instead be performed at the autonomous vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure cover such alterations, variations, and/or equivalents.

What is claimed is:

1. A computer-implemented method for generating motion plans for autonomous vehicles, the method comprising:
obtaining, by a computing system with one or more processors, sensor data for an area around an autonomous vehicle;
detecting, by the computing system, one or more objects in the area around the autonomous vehicle based at least in part on the sensor data;
determining, by the computing system using one or more machine-learned models, a plurality of candidate object trajectories for each object in the one or more objects;
for each respective object in the one or more objects, generating, by the computing system using the plurality of candidate object trajectories as input to one or more machine-learned models, likelihood data for the plurality of candidate object trajectories;
determining, by the computing system using the likelihood data for the plurality of candidate object trajectories for the one or more objects as input into the one or more machine learned models, updated likelihood data for each of the plurality of candidate object trajectories for each respective object in the one or more objects based on the likelihood values associated with candidate object trajectories for other objects in the one or more objects; and
determining, by the computing system, a motion plan for the autonomous vehicle, wherein determining the motion plan comprises:
generating, by the computing system, a plurality of candidate vehicle trajectories for the autonomous vehicle;
generating, by the computing system using the one or more machine-learned models, a cost value for each candidate vehicle trajectory in the plurality of candidate vehicle trajectories for the autonomous vehicle;
determining, by the computing system, a pairwise cost for each respective candidate vehicle trajectory for the autonomous vehicle based, at least in part, on the cost value for the respective candidate trajectory for the autonomous vehicle and the updated likelihood values for the candidate object trajectories for the one or more objects; and
selecting, by the computing system, a candidate vehicle trajectory from the plurality of candidate vehicle trajectories based, at least in part, on the pairwise cost for the candidate vehicle trajectory.

2. The computer-implemented method of claim 1, wherein a respective model in the one or more machine-learned models is a deep-structured self-driving network that includes a plurality of subsections, each subsection producing an interpretable intermediate representation.

3. The computer-implemented method of claim 1, wherein the cost value for each candidate vehicle trajectory for the autonomous vehicle is a unary cost value.

4. The computer-implemented method of claim 1, wherein the unary cost value is generated by using feature data associated with the autonomous vehicle and feature data associated with one or more candidate vehicle trajectories as input to a motion planning module of the one or more machine-learned models.

5. The computer-implemented method of claim 1, wherein generating likelihood data for each candidate object trajectory in the plurality of candidate object trajectories comprises:
for each object in the one or more objects:
determining, by the computing system, feature data associated with the object;
determining, by the computer system, trajectory feature data associated with each candidate object trajectory; and
using the feature data and the trajectory feature data as input to a motion forecasting module of the machine-learned model.

6. The computer-implemented method of claim 5, further comprising:
providing, by the computing system, environmental feature data as input to the motion forecasting module.

7. The computer-implemented method of claim 1, wherein the likelihood data is a probability distribution that represents the likelihood of a particular object following each of the candidate object trajectories.

8. The computer-implemented method of claim 1, wherein determining, by the computing system using likelihood data for the plurality of candidate object trajectories for the one or more objects as input into the one or more machine learned models, updated likelihood data for each of the plurality of candidate object trajectories for each respective object in the one or more objects based on the likelihood values associated with candidate object trajectories for other objects in the one or more objects, comprises:
generating, by the computing system using the one or more machine learned models, updated likelihood data based at least in part on a message passing stage in the one or more machine learned models in which the likelihood data for a respective plurality of candidate object trajectories associated with the respective object are compared to likely trajectories of one or more other candidates.

9. The computer-implemented method of claim 1, further comprising:
processing, by the computing system, the sensor data to produce an intermediate representation of the area around the autonomous vehicle.

10. The computer-implemented method of claim 1, wherein the one or more objects comprises at least one vehicle.

11. The computer-implemented method of claim 1, wherein detecting the one or more objects in the area around the autonomous vehicle based at least in part on the sensor data comprises:
determining, by the computing system, a bounding box location associated with each object in the one or more objects and an initial velocity associated with each objected in the one or more objects.

12. The computer-implemented method of claim 1, further comprising:
selecting, by the computing system, a trajectory from the plurality of candidate trajectories based on the cost value associated with the trajectory.

13. An autonomous vehicle, comprising:
a machine-learned motion planning model configured to receive sensor data and map data associated with an environment external to an autonomous vehicle and process the sensor data and the map data to generate a target motion plan for the autonomous vehicle, the machine-learned motion planning model comprising:
a backbone network configured to receive the sensor data and the map data as input and generate one or more intermediate representations associated with at least one object as output,
a trajectory sampler configured to evaluate a plurality of candidate object trajectories for the at least one object,
a multi-modal uncertainty calculator configured to generate likelihood data for the plurality of candidate object trajectories for the at least one object; and
a cost calculator configured to generate a cost for one or more candidate vehicle trajectories for the autonomous vehicle based at least in part on the likelihood values.

14. The autonomous vehicle of claim 13, further comprising:
one or more processors; and
one or more non-transitory computer-readable media that collectively store instructions that, when executed by the one or more processors, cause the one or more processors to perform operations, the operations comprising:
obtaining, by the backbone network, sensor data for an area around the autonomous vehicle;
producing, by the backbone network, an interpretable intermediate representation of the area around the autonomous vehicle;
detecting, by the backbone network, a plurality of objects in the area around the autonomous vehicle based at least in part on the interpretable intermediate representation of the area around the autonomous vehicle;
determining, by the trajectory sampler, a plurality of candidate object trajectories for each object in the plurality of objects;
for each respective object in the plurality of objects, generating, by using the plurality of candidate object trajectories for the respective object as input to the multi-modal uncertainty calculator, likelihood data for each candidate object trajectory in the plurality of candidate object trajectories;
determining, by using the likelihood data for the plurality of candidate object trajectories for the one or more objects as input the multi-modal uncertainty calculator, updated likelihood data for the plurality of candidate object trajectories for each respective object based on the likelihood values associated with candidate object trajectories for the other objects; and
determining, by the cost calculator, a motion plan for the autonomous vehicle, based at least in part, on the updated likelihood values for the plurality of candidate object trajectories for each respective object.

15. The autonomous vehicle of claim 14, wherein each voxel has a binary value indicating whether the voxel includes a LIDAR point.

16. The autonomous vehicle of claim 15, wherein producing the intermediate representation of the area around the autonomous vehicle further comprises:
concatenating the voxelized representation of the sensor data at a plurality of time steps to generate a three-dimensional tensor representation of the sensor data.

17. A non-transitory computer-readable medium storing instruction that, when executed by one or more computing devices, cause the one or more computing devices to perform operations, the operations comprising:
obtaining sensor data for an area around an autonomous vehicle;
detecting one or more objects in the area around the autonomous vehicle based at least in part on the sensor data;
determining, using one or more machine-learned models, a plurality of candidate object trajectories for each object in the one or more objects;
generating, using one or more machine-learned models, a likelihood value for each candidate object trajectory in the plurality of candidate object trajectories; and
determining a motion plan for the autonomous vehicle, wherein determining the motion plan comprises:
generating a plurality of candidate vehicle trajectories for the autonomous vehicle;
generating, using the one or more machine-learned models, a cost value for each candidate trajectory in the plurality of candidate vehicle trajectories for the autonomous vehicle; and
determining a pairwise cost for each respective candidate vehicle trajectory for the autonomous vehicle based, at least in part, on the cost value for the respective candidate trajectory for the autonomous vehicle and the updated likelihood values for the candidate object trajectories for the one or more objects.

18. The non-transitory computer-readable medium of claim 17, wherein the machine-learned model is a structured network that includes a plurality of subsections with each subsection producing an interpretable intermediate representation.

19. The non-transitory computer-readable medium of claim 17, wherein the cost value for each candidate trajectory for the autonomous vehicle is a unary cost value.

20. The non-transitory computer-readable medium of claim 17, wherein the unary cost value is generated by using feature data associated with the autonomous vehicle and feature data associated with the one or more candidate trajectories as input to a motion planning module of the machine-learned model.
